(19) United States
(12) Patent Application Publication
(10) Pub. No.: US 2013/0021649 A1
(43) Pub. Date: Jan. 24, 2013

(54) HOST, IMAGE FORMING APPARATUS AND CONTROL METHOD THEREOF

(71) Applicants: Yang Woo Lee, Suwon-si (KR); Hong Won Hong, Anyang-si (KR)

(72) Inventors: Yang Woo Lee, Suwon-si (KR); Hong Won Hong, Anyang-si (KR)

(73) Assignee: SAMSUNG ELECTRONICS CO., LTD., Suwon (KR)

(21) Appl. No.: 13/551,974

(22) Filed: Jul. 18, 2012

(30) Foreign Application Priority Data
Jul. 22, 2011 (KR) 10-2011-0072956

(51) Int. Cl. G06K 15/02

(52) U.S. Cl. 358/1.15

(57) ABSTRACT

A host includes a user interface unit configured to receive an output command of a verification document, a image code generating unit configured to generate an image code, which includes time information, a control unit configured to perform control such that the verification document is output from an image forming apparatus by using a print data and the image code, and a communication interface unit configured to transmit the image code and the print data to the image forming apparatus. A image forming apparatus includes an user interface unit configured to receive an output command of a verification document, an image code generating unit configured to generate an image code including time information, and a control unit configured to perform control such that the verification document is generated by printing the image code and a print data, which is transmitted from a host, on a document and the generated verification document is output.

### CROSS-REFERENCE TO RELATED APPLICATIONS

This application claims priority to Korean Patent Application No. 10-2011-0072956, filed on Jul. 22, 2011 in the Korean Intellectual Property Office, the disclosure of which is incorporated herein by reference.

### BACKGROUND

1. Field

Embodiments of the present invention relate to a host, an image forming apparatus, and a control method, capable of outputting a verification document.

2. Description of the Related Art

In general, for two parties to proceed with signing a written contract with reference to the items to be contracted, the two parties prepare two written contracts, and each party keeps one of the two signed, written contracts as a means of evidence. In order to authenticate the two written contracts, both parties use stamps sealed or written signatures endorsed on both written contracts after placing the written documents together side by side. However, in a case when stamps are used, the seal of the stamp may not be clearly endorsed, and in a case when written signatures are endorsed, the boundary of the two written contracts may cause a difficulty in signing. As to supplement such disadvantages, an image generating apparatus is under development to verify an authenticity of a contract. However, image generating apparatus uses a same signature, and executes an endorsement of a signature of a user by using a pre-stored password of a user; and such method possesses a security concern.

### SUMMARY

Therefore, it is an aspect of the present disclosure to provide a host, an image forming apparatus, and a control method, capable of outputting a verification document with enhanced security.

Additional aspects will be set forth in part in the description which follows and, in part, will be obvious from the description, or may be learned by practice of the disclosure.

In accordance with one aspect, an image forming apparatus includes a user interface unit of the image forming apparatus, an image code generating unit of the image forming apparatus and a control unit of the image forming apparatus. The user interface unit is configured to receive an output command of a verification document. The image code generating unit is configured to generate an image code including time information upon receiving the output command to output the verification document. The control unit is configured to perform control such that the verification document is generated by printing the image code and a print data, which is transmitted from a host, on a document and the generated verification document is output.

The user interface unit outputs a user interface screen which receives information on signature, and the image forming apparatus further includes a storage unit of the image forming apparatus configured to store the information on signature if the information on signature is received.

The image code generating unit generates an image code which includes the information on signature.

The image code generating unit generates the image code if the output command of the verification document is input through the host, and the control unit generates the verification document if the output command of the verification document is received through the user interface unit of the image forming apparatus or the output command of the verification document is received through the host.

The image code includes at least one of a one-dimensional code and a two-dimensional code.

The control unit of the image forming apparatus, in a case when a plurality of the verification documents are output, print the image code while being divided on each document of the plurality of the verification documents.

When the image code is printed while being divided on each document of the plurality of the verification documents, a part of the image code is printed on a first page of the plurality of the verification documents while another part of the image code is printed on a second page of the plurality of the verification documents.

The time information refers to time information randomly selected prior to the image code generated after the output command of the verification document, or time information of when the image code is being generated.

In accordance with another aspect, an image forming apparatus a communication interface unit of the image forming apparatus and a control unit of the image forming apparatus. The communication interface unit is configured to receive an image code and a print data from a host to output a verification document. The control unit is configured to perform control such that the verification document is generated by printing the image code and the print data on a document and the generated verification document is output.

The image code includes time information randomly selected prior to the image code generated after an output command of the verification document, or time information of when the image code is being generated.

The image code includes at least one of a one-dimensional code and a two-dimensional code.

The image code includes information on signature which is input by a user.

The image forming apparatus further includes a user interface unit of the image forming apparatus configured to set a printing area where the image code is printed on the document.

In accordance with another aspect, a host includes a user interface unit of the host, an image code generating unit of the host, a control unit of the host and a communication interface unit of the host. The user interface unit is configured to receive an output command of a verification document. The image code generating unit is configured to generate an image code, which includes time information, upon receiving the output command of the verification document. The control unit of the host is configured to perform control such that the verification document is output from an image forming apparatus by using a print data and the image code. The communication interface unit is configured to transmit the image code and the print data to the image forming apparatus.

The image code generating unit generates an image code which includes time information about generating the image code.

The user interface unit outputs a user interface screen which is used to operate a driver of the image forming apparatus, and the user interface screen is configured to receive information on signature.

The image code generating unit generates an image code which includes the information on signature.

The image code includes at least one of a one-dimensional code and a two-dimensional code.

The time information refers to time information randomly selected prior to the image code generated after the output command of the verification document, or time information of when the image code is being generated.

In accordance with another aspect, a control method of an image forming apparatus is as follows. An output command of a verification document is received. An image code which includes time information is generated upon receiving the output command of the verification document. A control is performed such that the verification document is generated by printing a print data transmitted from a host and the image code on a document and the generated verification document is output.

The time information refers to time information randomly selected prior to the image code generated after the output command of the verification document, or time information of when the image code is being generated.

The image code includes at least one of a one-dimensional code and a two-dimensional code.

In a case when a plurality of the verification documents is output, the image code is printed while being divided on each document of the plurality of the verification documents.

When the image code is printed while being divided on each document of the plurality of the verification documents, a part of the image code is printed on a first page of the plurality of the verification documents while another part of the image code is printed on a second page of the plurality of the verification documents.

In accordance with another aspect of the present disclosure, a control method of an image forming apparatus is as follows. An image code and a print data are received from a host to output a verification document. A control is performed such that the verification document is generated by printing the print data and the image code on a document, and the generated verification document is output.

The image code includes time information randomly selected prior to the image code generated after an output command of the verification document, or time information of when the image code is being generated.

The image code includes at least one of a one-dimensional code and a two-dimensional code.

The image code includes information on signature which is input by a user.

In accordance with another aspect, a control method of a host is as follows. An output command of a verification document is received. An image code which includes time information is generated upon receiving the output command of the verification document. The image code and a print data are transmitted to an image forming apparatus such that the verification document is output.

The image code includes time information about generating the image code.

The method further includes receiving information on signature of a user and including the information on signature in the image code.

The image code includes at least one of a one-dimensional code and a two-dimensional code.

According to an aspect of the present disclosure described above, verification document with enhanced security and reliability can be output, since an image code is also printed on the verification document.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a status of an image forming apparatus connected to a host according to an embodiment of the present disclosure.

FIG. 2A is a control -block diagram of a host according to the embodiment of the present disclosure.

FIG. 2B is a control-block diagram of an image forming apparatus according to the embodiment of the present disclosure.

FIGS. 3A and 3B are views illustrating screens which show an operation of the image forming apparatus driver according to the embodiment of the present disclosure.

FIG. 4A is a control-block diagram of a host according to another embodiment of the present disclosure.

FIG. 4B is a control-block diagram of an image forming apparatus according to the other embodiment of the present disclosure.

FIG. 5 is a view illustrating a screen which is output from image forming apparatus a user interface unit of the image forming apparatus according to the other embodiment of the present disclosure.

FIG. 6 is a view illustrating a verification document which is output from the image forming apparatus according to the embodiment of the present disclosure.

FIG. 7 is a view illustrating a plurality of verification documents which is output from the image forming apparatus according to the example of the present disclosure.

FIG. 8 is a view illustrating another example of a plurality of verification documents which is output from the image forming apparatus according to the embodiment of the present disclosure.

FIG. 9A is a flow chart explaining a process of generating an image code from the host in order to be transmitted to the image forming apparatus according the the embodiment of the present disclosure.

FIG. 9B is a flow chart illustrating a process of outputting a verification document from the image forming apparatus according to the embodiment of the present disclosure.

FIG. 10 is a flow chart illustrating a process of generating an image code and outputting a verification document in an image forming apparatus according to another embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

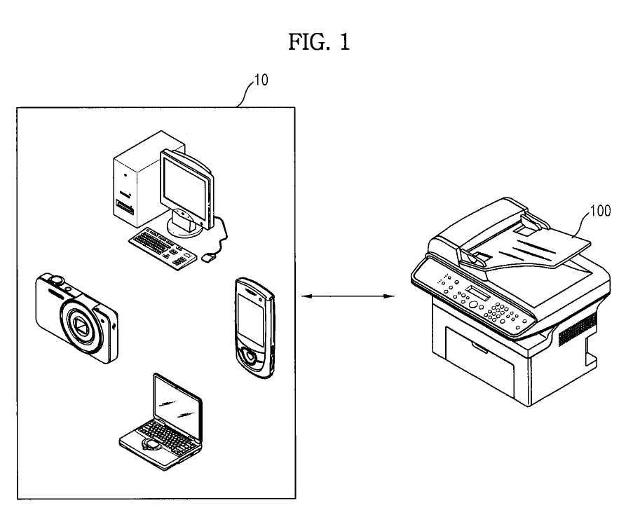

FIG. 1 is a view illustrating a status of an image forming apparatus connected to a host according to an embodiment of the present disclosure.

A host 10 is connected to an image forming apparatus 100 via a network. The host 10 receives a print data from a user and is established with a print option by a user. The host 10 transmits information on the print option along with the print data to the image forming apparatus 100.

The host 10 is installed with an image forming apparatus driver to control the image forming apparatus 100. The host 10 outputs a user interface screen to control the image forming apparatus driver. The user interface screen may be a touch-screen that a user can operate the image forming apparatus driver by touching on the surface of a screen. The user interface screen may be a conventional monitor screen that may be operated by use of a mouse.

An image forming apparatus 100 may perform a printing operation according to the print data and print option transmitted from a host 10. However, the image forming apparatus 100 may receive print data directly via a memory, and execute a printing operation according to print option set by a user.

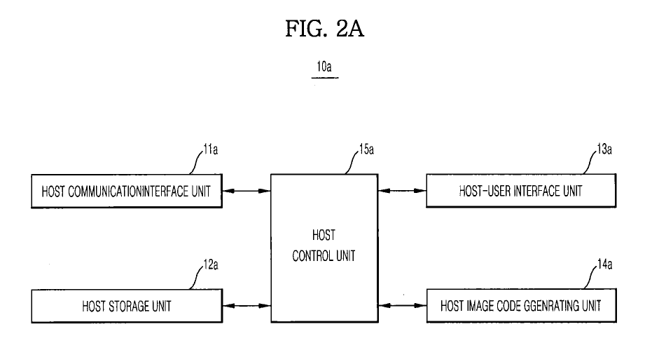

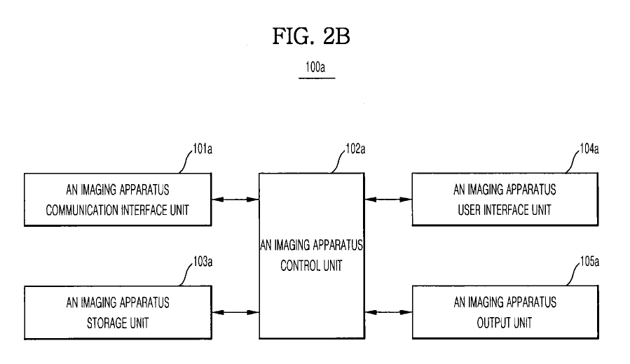

FIG. 2A is a control -block diagram of a host according to the embodiment of the present disclosure.

A host 10a may include a host communication interface unit 11a, a host storage unit 12a, a host-user interface unit 13a, a host image code generating unit 14a, and a host control unit 15a.

The host communication interface unit 11a connects the host 10a and the image forming apparatus 110 via a network. The host communication interface unit 11a transmits data, which may be processed at the image forming apparatus 100, to the image forming apparatus 100. The data which may be processed at the image forming apparatus 100 may include PDL (Page Description Language) data and XPS files, which are prepared in a PCL (Page Command Language) language and a PS (Post Script) language. The host communication interface unit 11a may be composed of a parallel port, a USB (Universal Serial Bus) port or a wireless module.

The host storage unit 12a may store the print data inputted by a user. The host storage unit 12a may store various programs related to an installation of the image forming apparatus driver.

The host-user interface unit 13a may be equipped with a plurality of function keys, which may establish or select various functions supported by the host 10a. The host-user interface unit 13a may be implemented by an apparatus which may achieve input and output functions simultaneously, such as a touch pad. Alternatively, the host-user interface unit 13a may be implemented by a combination of apparatuses such as a mouse and a monitor.

The host-user interface unit 13a may output a user interface screen to operate the image forming apparatus driver. The image forming apparatus driver represents a program which enables the host 10a to operate the image forming apparatus 100.

The host-user interface unit 13a receives an operation command from a user after displaying the user interface screen used to operate the image forming apparatus driver, and then transmits the received information to the host control unit 15a.

The host-user interface unit 13a may output an “area for signature” 50 on the user interface screen.

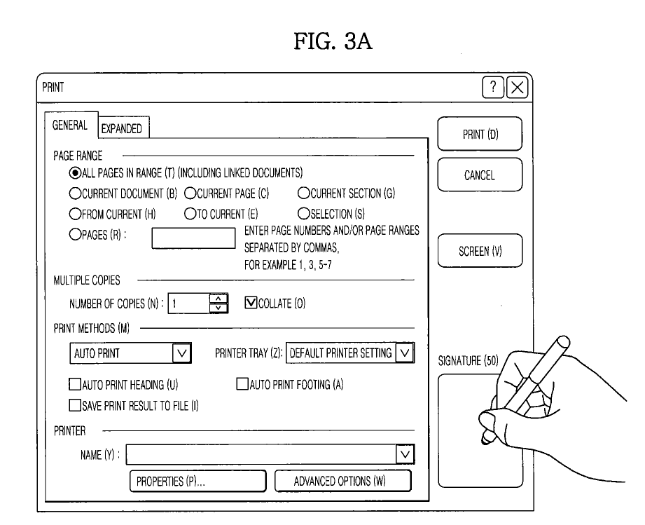

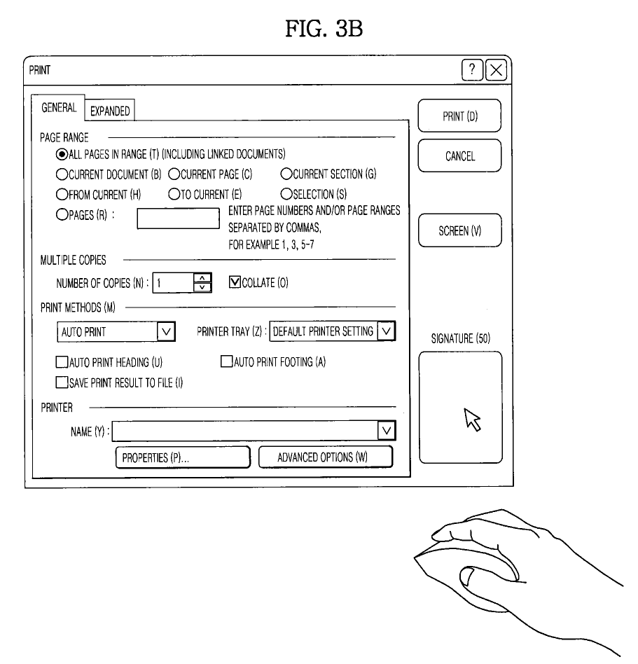

In a case when the host-user interface unit 13a is implemented by the apparatus which may achieve input and output functions simultaneously, such as a touch pad, a signature is input by touching on the “area for signature” 50. Referring to FIG. 3A, the “area for signature” 50 is displayed, and a signature may be input directly by a user by using a touch pen 51, etc.

When the host-user interface unit 13a is implemented by a combination of a mouse and a monitor, a signature is input by operating the mouse to correspond to the “area for signature” 50. Referring to FIG. 3B, the “area for signature ” is displayed, and a signature may be input directly by a user by using a mouse 51.

If a user designates a print data and establishes a print option, the host-user interface unit 13a transmits information about the print data and print option to the host control unit 15a. If a signature is input by a user, the host-user interface unit 13a transmits information about the signature to the host control unit 15a.

The host-user interface unit 13a may receive an output command of a verification document from a user. The verification document represents a document which authenticates the content of the document made by a user.

The host image code generating unit 14a may generate an image code which includes time information of when a user inputs an output command of a verification document or time information randomly selected prior to the image code generated after the output command of the verification document. Alternatively the host image code generating unit 14a may generate an image code which includes time information of when the image code is generated.

The image code includes a one-dimensional code and a two-dimensional code. The one-dimensional code may be a bar code; and a bar code into which numeric information is input, is horizontally arranged, and contains a one-dimensional structure. The two-dimensional code may be a QR code; and a QR code is vertically and horizontally arranged, and may record numeric, alphanumeric, or Kanji-based information while having a two-dimensional structure.

The host image code generating unit 14a, in order to enhance reliability in verification during a process of generating an image code, may additionally include information on a signature of a user, information on a document, and as well as information of a drafter. The information that an image code includes is needed to verify the authentication of a verification document, and therefore, various information other than already described above may be included.

The host control unit 15a, if a user inputs the information on a print data and print option via the host-user interface unit 13a, controls the host communication interface unit 11a to transmit the input information to the image forming apparatus 100.

The host control unit 15a, if a user inputs an output command of a verification document, may transmit the information to the host image code generating unit 14a.

The host control unit 15a may transmit print data, print option, and an image code to the image forming apparatus 100 and control a process in output a verification document.

FIG. 2B is a control-block diagram of an image forming apparatus according to the embodiment of the present disclosure.

An image forming apparatus 100a includes an image forming apparatus communication interface unit 101a, an image forming apparatus control unit 102a, an image forming apparatus storage unit 103a, an image forming apparatus user interface unit 104a, and an image forming apparatus output unit 105a.

The image forming apparatus communication interface unit 101a is provided to be connected to a host 10, such as a PC, a notebook, a PDA, a digital camera, etc. The image forming apparatus communication interface unit 101a is provided to connect the image forming apparatus 100 to an outside apparatus; and may be implemented in a form that may be accessed to the host 10 via a LAN (Local Area Network) or the Internet, or be directly connected to the host 10 via a USB (Universal Serial Bus) or a serial port.

Then image forming apparatus control unit 102a may print a data by receiving a print data and a print option transmitted from the host 10. The image forming apparatus control unit 102a may receive an image code which is transmitted from the host 10 and print the received image code on a document being output.

The image forming apparatus control unit 102a, if an output command to output a verification document is made by a user, may composite an image code onto a received print data.

The image forming apparatus storage unit 103a may store various programs needed to operate the image forming apparatus 100a. The image forming apparatus storage unit 103a may store a data transmitted via the host 10. The image forming apparatus storage unit 103a may store an image code transmitted via the host 10.

The image forming apparatus user interface unit 104a may be equipped with various functions supported by the image forming apparatus 100a so that a user may establish or select various functions. The image forming apparatus user interface unit 104a may display various information provided by the image forming apparatus 100a. The image forming apparatus user interface unit 104a may also be implemented by the apparatus which may achieve input and output functions simultaneously, such as a touch pad. A user may operate the image forming apparatus user interface unit 104a to establish a work area, a document area, a page area, a specific language character area, and an image area. A user may establish a print area on a document, by adjusting the image forming apparatus user interface unit 104a, where an image code is printed on.

The image forming apparatus output unit 105a may output a print data on a document. The image forming apparatus output unit 105a may output a document on which an image code and a print data are printed.

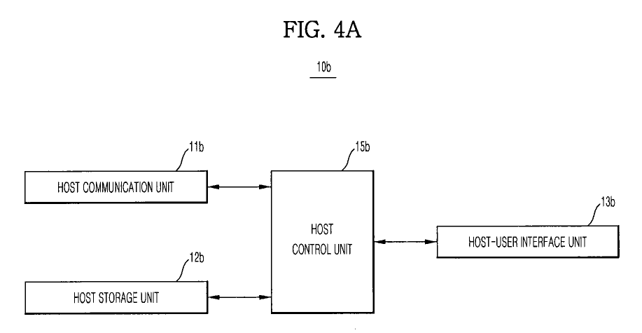

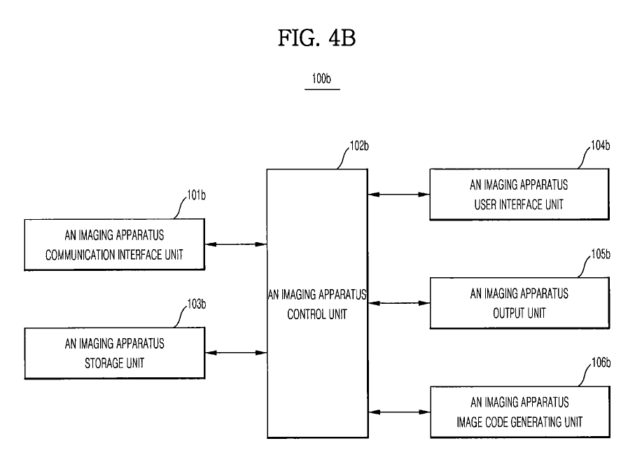

FIG. 4A is a control-block diagram of a host according to another embodiment of the present disclosure.

A host 10b may include a host communication interface unit 11b, a host control unit 15b, a host storage unit 12b and a host-user interface unit 13b.

When compared with FIG. 2A, the host image code generating unit 14a is excluded. The host 10b, via a host communication interface unit 11b, is connected to the image forming apparatus 100 in a network, and transmits a data that may be processed at the image forming apparatus 100 to the image forming apparatus 100. The host storage unit 12b stores various programs needed to operate the host 10b.

The host-user interface unit 13b may output a user interface screen in to operate the image forming apparatus driver. The host-user interface unit 13b, after a user interface screen is shown to operate the image forming apparatus driver, receives an operation command from a user, and may transmit the input information to the host control unit 15b.

The host-user interface unit 13b may receive an output command of a verification document from a user. The verification document represents a document that authenticates the content on a document made by a user.

The host control unit 15b, as a user inputs a print data and a print option via the host-user interface unit 13b, controls the host communication interface unit 11b so that the information may be transmitted to the image forming apparatus 100.

FIG. 4B is a control -block diagram of an image forming apparatus according to the other embodiment of the present disclosure.

When FIG. 4b is compared to FIG. 2b, an image forming apparatus image code generating unit is added.

An image forming apparatus 100b includes an image forming apparatus communication interface unit 101b, an image forming apparatus control unit 102b, an image forming apparatus image code generating unit 106b, an image forming apparatus storage unit 103b, an image forming apparatus user interface unit 104b, and an image forming apparatus output unit 105b.

The image forming apparatus communication interface unit 101b is provided to connect the image forming apparatus 100b to the host 10, such as a PC, a notebook, a PDA, a digital camera, etc.

The image forming apparatus user interface unit 104b may be equipped with various functions supported by an image forming apparatus 100b so that a user may establish or select various functions. The image forming apparatus user interface unit 104b may display various information provided by the image forming apparatus 100b. The image forming apparatus user interface unit 104b may also be implemented by the apparatus which may achieve input and output functions simultaneously, such as a touch pad. A user may operate the image forming apparatus user interface unit 104b to establish a work area, a document area, a page area, a specific language character area, and an image area. A user may establish a print area on a document, by adjusting the image forming apparatus user interface unit 104b, where an image code is printed on.

The image forming apparatus user interface unit 104b may receive an output command to output a verification document by a user. The image forming apparatus user interface unit 104b, when an output command to output a verification document is received by a user, transmits the information to the image forming apparatus control unit 102b.

The image forming apparatus user interface unit 104b may show an “area for signature” on a user interface screen.

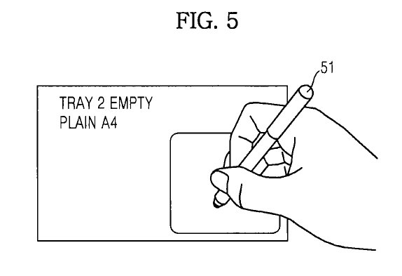

In a case when the image forming apparatus user interface unit 104b is implemented by the apparatus which may achieve input and output functions simultaneously, such as a touch pad, the “area for signature” may be touched on to input a signature. Referring to FIG. 5, an “area for signature” is shown on a screen generated by the image forming apparatus user interface unit 104b; and by using a touch pen 51, etc., a signature may be input directly by a user.

The image forming apparatus control unit 102b may receive a print data and a print option from the host 10b and controls a process of printing data.

When an output command to output a verification document is input via the image forming apparatus user interface unit 104b or via the host 10a, the image forming apparatus control unit 102b, prints an image code, which is generated by the image forming apparatus image code generating unit 106b, on a received print data. Details of the image forming apparatus image code generating unit 106b will be explained later.

The image forming apparatus image code generating unit 106b may generate an image code to be used for a verification document. The image code may include time information randomly selected prior to the image code generated after an output command of the verification document. The image code may include time information of when the image code is being generated. The image code may include other information, in addition to the time information, that may be helpful in verifying the authentication of a verification document. For example, the information which is helpful in verifying the authentication of a verification document include information on a signature of a user, information on a document, and as well as information of a drafter. The information on a signature of a user may be input via the image forming apparatus user interface 104b or via the host 10b.

The image forming apparatus storage unit 103b may store a data to be printed. The image forming apparatus storage unit 103b may store an image code. The image code to be stored in an image forming apparatus storage unit 103b is for one-time use only, and once the image code is used for an output of a verification document, the information may be deleted.

The image forming apparatus output unit 105b may output a print data on a document. The image forming apparatus output unit 105b may output a document on which a print data and an image code are printed.

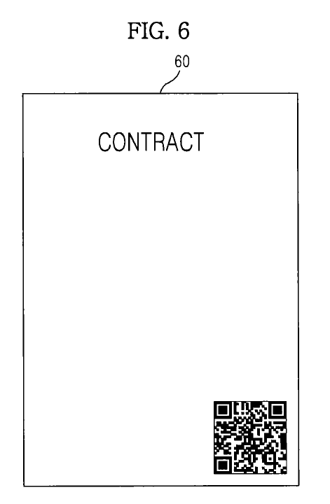

FIG. 6 is a view illustrating a verification document which is output from the image forming apparatus according to the embodiment of the present disclosure.

The image forming apparatus 100, if an output command to output a verification document is input, prints and outputs an image code, which contains time information, on a document. The image code is formed by the host 10 or the image forming apparatus 100. The image code may include a one-dimensional code and a two-dimensional code.

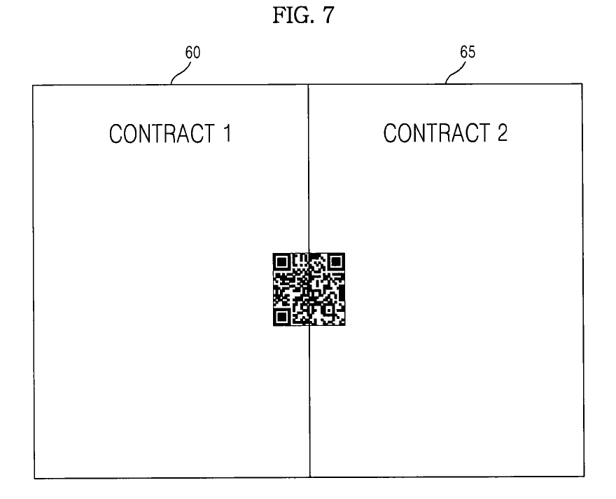

FIG. 7 is a view illustrating a plurality of verification documents which is output from the image forming apparatus according to the example of the present disclosure.

The image forming apparatus 100 may output an image code between a first verification document 60 and a second verification document 65. A part of the image code may input on the first verification document 60, and another part of the image code may be input on the second verification document 65. An image code analysis apparatus places a first verification document 60 and a second verification document 65 in parallel; and after setting a structure of an image code, the image code may be collected for an analysis.

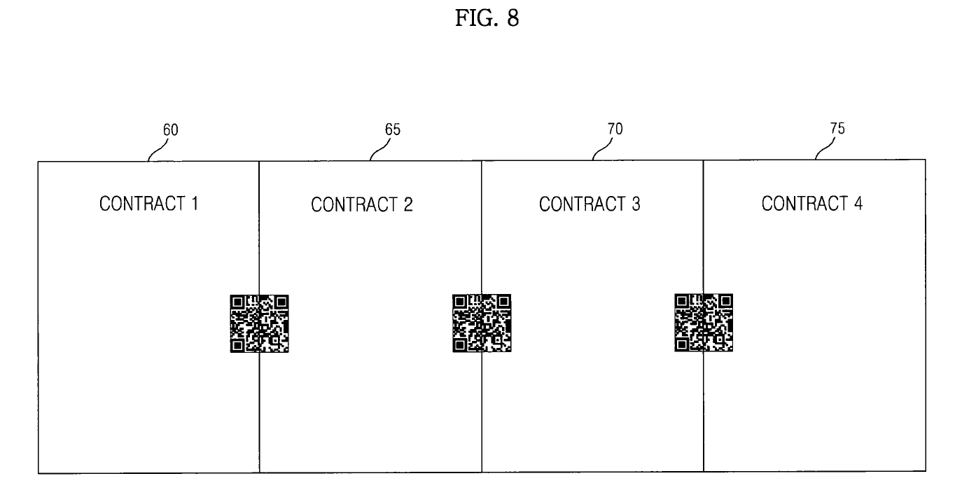

FIG. 8 is a view illustrating another example of a plurality of verification documents which is output from the image forming apparatus according to the embodiment of the present disclosure.

The image forming apparatus 100 may output three of more verification documents including a first, a second, a third and a fourth verification documents 60, 65, 70, and 75. The image forming apparatus 100 may print an image code in the order of which the verification documents being output. A first image code is divided and printed into the first verification document 60 and the second verification document 65; a second image code is divided and printed into the second verification document 65 and the third verification document 70; and a third image code is divided and printed into the third verification document 70 and the fourth verification document 75.

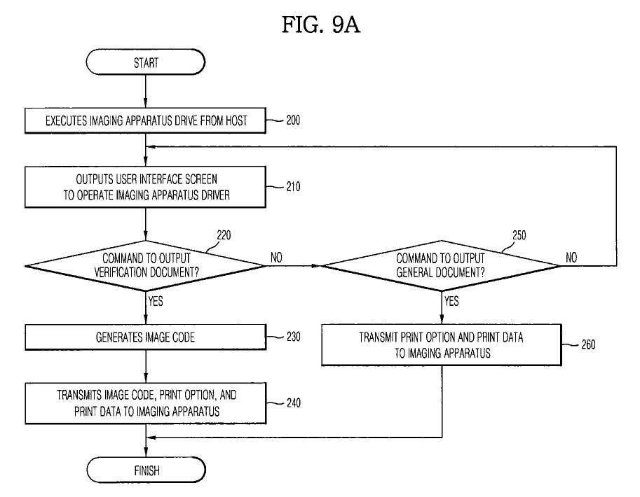

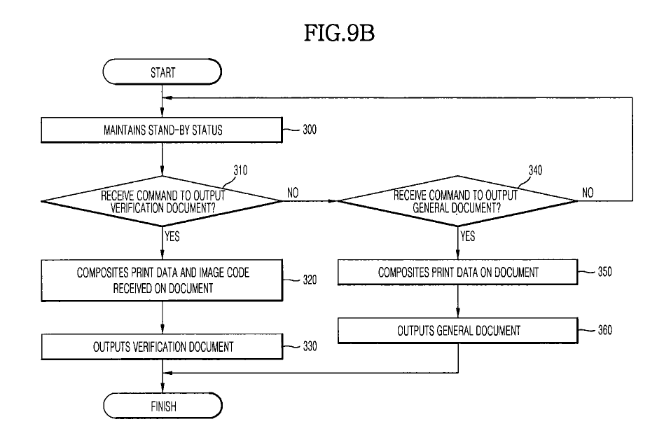

FIG. 9A is a flow chart explaining a process of generating an image code from the host in order to be transmitted to the image forming apparatus according to the embodiment of the present disclosure

If a user executes an image forming apparatus driver (200), the host 10, outputs a user interface screen to operate the image forming apparatus driver (210).

The host 10 confirms if an output command to output a verification document is input by a user (220). The host 10, if a confirmation is made that an output command to output a verification document is input by a user, generates an image code (230). The image code includes time information. The image code may include information on a signature input by a user. The information on a signature may be input on an “area for signature” displayed on a user interface screen.

The host 10 transmits a print data, information on a print option, and an image code to the image forming apparatus 100 (240).

The host 10, if no command to output a verification document by a user is present, confirms if a command to output a general document is present (250). The host 10, if a command to output a general document is present, transmits a print data and a print option to the image forming apparatus 100 (260).

FIG. 9B is a flow chart illustrating a process of outputting a verification document from the image forming apparatus according to the embodiment of the present disclosure.

The image forming apparatus 100, if a power is on, maintains a standby status before an output command to output a document is input. (300)

The image forming apparatus 100, if an output command to output a verification document is input from the host 10 (310), receives and prints a print data and an image code on a document (320). The image code may be adjusted in size and print position according to a print option transmitted from the host 10.

The image forming apparatus 100 outputs a document on which the print data and the image code are printed (330).

The image forming apparatus 100, if a command to output a general document from the host 10 is input, prints a print data on a document, and then output. (340, 350, and 360)

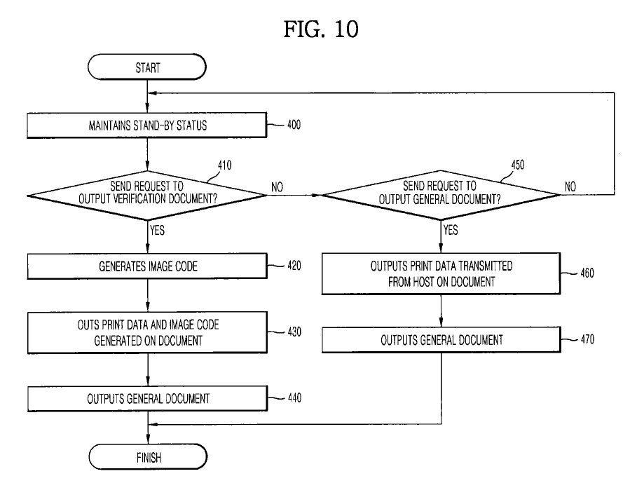

FIG. 10 is a flow chart illustrating a process of generating an image code and outputting a verification document in an image forming apparatus according to another embodiment of the present disclosure.

The image forming apparatus 100, if a power is on, maintains a standby status before an output command to output a document is input. (400)

The image forming apparatus 100, if an output command to output a verification document is input (410), generates an image code (420). The image code may include time information. The image code, other than time information, may include information on a signature.

The image forming apparatus 100 receives a print data from the host 10, prints the print data received and the image code generated on a document (430), and then outputs a verification document (440).

The image forming apparatus 100, if no command to output a verification document by a user is present, confirms if a command to output a general document is present (450). The image forming apparatus 100, if a command to output a general document is present, prints a print data, which is transmitted from the host 10 (460), on a document, and then outputs a general document(470).

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An image forming apparatus comprising:
a user interface unit configured to receive an output command of a verification document;
an image code generating unit configured to generate an image code including time information upon receiving the output command to output the verification document ; and
a control unit configured to perform control such that the verification document is generated by printing the image code and a print data, which is transmitted from a host, on a document and the generated verification document is output.

2. The image forming apparatus of claim 1, wherein the user interface unit outputs a user interface screen which receives information on signature, and the image forming apparatus further comprises a storage unit configured to store the information on signature if the information on signature is received.

3. The image forming apparatus of claim 2, wherein the image code generating unit generates an image code which comprises the information on signature.

4. The image forming apparatus of claim 1, wherein the image code generating unit generates the image code if the output command of the verification document is input through the host, and the control unit generates the verification document if the output command of the verification document is received through the user interface unit or the output command of the verification document is received through the host.

5. The image forming apparatus of claim 1, wherein the image code comprises at least one of a one-dimensional code and a two-dimensional code.

6. The image forming apparatus of claim 1, wherein the control unit, in a case when a plurality of the verification documents is output, prints the image code while being divided on each document of the plurality of the verification documents.

7. The image forming apparatus of claim 6, wherein when the image code is printed while being divided on each document of the plurality of the verification documents, a part of the image code is printed on a first page of the plurality of the verification documents while another part of the image code is printed on a second page of the plurality of the verification documents.

8. The image forming apparatus of claim 1, wherein the time information refers to time information randomly selected prior to the image code generated after the output command of the verification document, or time information of when the image code is being generated.

9. An image forming apparatus comprising:
a communication interface unit configured to receive an image code and a print data from a host to output a verification document; and
a control unit configured to perform control such that the verification document is generated by printing the image code and the print data on a document and the generated verification document is output.

10. The image forming apparatus of claim 9, wherein the image code comprises time information randomly selected prior to the image code generated after an output command of the verification document, or time information of when the image code is being generated.

11. The image forming apparatus of claim 9, wherein the image code comprises at least one of a one-dimensional code and a two-dimensional code.

12. The image forming apparatus of claim 9, wherein the image code comprises information on signature which is input by a user.

13. The image forming apparatus of claim 9, further comprising a user interface unit configured to set a printing area where the image code is printed on the document.

14. A host comprising:
a user interface unit configured to receive an output command of a verification document;
an image code generating unit configured to generate an image code, which comprises time information, upon receiving the output command of the verification document;
a control unit configured to perform control such that the verification document is output from an image forming apparatus by using a print data and the image code; and
a communication interface unit configured to transmit the image code and the print data to the image forming apparatus.

15. The host of claim 14, wherein the image code generating unit generates an image code which comprises time information about generating the image code.

16. The host of claim 14, wherein the user interface unit outputs a user interface screen which is used to operate a driver of the image forming apparatus, and the user interface screen is configured to receive information on signature.

17. The host of claim 16, wherein the image code generating unit generates an image code which comprises the information on signature.

18. The host of claim 14, wherein the image code comprises at least one of a one-dimensional code and a two-dimensional code.

19. The host of claim 14, wherein the time information refers to time information randomly selected prior to the image code generated after the output command of the verification document, or time information of when the image code is being generated.

20. A control method of an image forming apparatus, the control method comprising:
receiving an output command of a verification document;
generating an image code which comprises time information upon receiving the output command of the verification document;
performing control such that the verification document is generated by printing a print data transmitted from a host and the image code on a document and the generated verification document is output.

21. The control method of claim 20, wherein the time information refers to time information randomly selected prior to the image code generated after the output command of the verification document, or time information of when the image code is being generated.

22. The control method of claim 20, wherein the image code comprises at least one of a one-dimensional code and a two-dimensional code.

23. The control method of claim 20, wherein in a case when a plurality of the verification documents is output, the image code is printed while being divided on each document of the plurality of the verification documents.

24. The control method of claim 23, wherein when the image code is printed while being divided on each document of the plurality of the verification documents, a part of the image code is printed on a first page of the plurality of the verification documents while another part of the image code is printed on a second page of the plurality of the verification documents.

25. A control method of an image forming apparatus, the control method comprising:
receiving an image code and a print data from a host to output a verification document;
performing control such that the verification document is generated by printing the print data and the image code on a document, and the generated verification document is output.

26. The control method of claim 25, wherein the image code comprises time information randomly selected prior to the image code generated after an output command of the verification document, or time information of when the image code is being generated.

27. The control method of claim 25, wherein the image code comprises at least one of a one-dimensional code and a two-dimensional code.

28. The control method of claim 25, wherein the image code comprises information on signature which is input by a user.

29. A control method of a host, the control method comprising:
receiving an output command of a verification document;
generating an image code which comprises time information upon receiving the output command of the verification document;
transmitting the image code and a print data to an image forming apparatus such that the verification document is output.

30. The control method of claim 29, wherein the image code comprises time information about generating the image code.

31. The control method of claim 29, further comprising receiving information on signature of a user and including the information on signature in the image code.

32. The control method of claim 29, wherein the image code comprises at least one of a one-dimensional code and a two-dimensional code.
